(19) United States
(12) Patent Application Publication
(10) Pub. No.: US 2009/0199267 A1
(43) Pub. Date: Aug. 6, 2009

(54) Internet filtering utility using consumer-governed internet web site ratings, governor voting system and vote validation process

(76) Inventor: David Glen Blackburn, Billere (FR)

Correspondence Address: David G. Blackburn, 6 Allee Miss Hutton, Billere, 64140, FR

(21) Appl. No.: 12/318,878

(22) Filed: Jan. 12, 2009

Related U.S. Application Data
(60) Provisional application No. 61/006,475, filed on Jan. 16, 2008.

(51) Int. Cl. G06F 21/00; G06F 17/30; G06F 3/00

(52) U.S. Cl. 726/1; 707/104.1; 715/741; 707/5; 707/E17.009; 707/E17.014; 707/E17.109

(57) ABSTRACT

Internet filtering system to produce only desirable internet search returns and to block undesirable web sites by computer administrators (herein called governors) wishing to limit the access of internet content for themselves, their children, their employees or clients, using a consumer-governed internet web site rating system that is verified with a governor voting system and vote validation process.

### CROSS REFERENCE TO RELATED APPLICATIONS

This non-provisional application corresponds to provisional patent application 61/006,475.

### BACKGROUND OF THE INVENTION

The internet, or World Wide Web, has made access to information, products, advertising and services accessible to virtually anyone who has a connection to the internet. Although the internet is an invaluable resource, it can provide information that some adults find offensive or unwanted, provide access to inappropriate content to under-aged minors and can make it difficult for employers to manage their employees' web access. Current access methods also make it difficult for public internet access points such as public libraries to limit internet access to inappropriate web sites.

The World Wide Web, herein referred to as the internet, is most commonly accessed through a web browser. Some of the most common are internet explorer, Mozilla, Firefox, Safari, Google Chrome, Opera and Netscape. Some developers have designed interface software and/or hardware solutions that crawl web sites, web pages, and internet addresses using a process of keyword analysis or dynamic categorization to determine whether the content of web sites, web pages or internet addresses (URLS) contain content deemed inappropriate for certain users or categories of users. These processes may produce false negatives and false positives and have difficulty filtering foreign language web sites. A false negative could block content of a web site or web page that might be benign because it contained a word that was associated in the list of blocked keywords. A false negative might not block the content of a web site or web page that has keywords embedded into files such as .jpg or .gif files, as keywords contained within certain embedded files may avert being crawled and analyzed. Basically, no automated system is foolproof.

Other developers have products that permit customers to review historical web access. This provides a reactive method for managing web access, but it does not proactively block web site access.

### SUMMARY OF THE INVENTION

The internet filtering system uses internet web site ratings (FIG. 1) to produce only desirable internet search returns within a web browser, blocks offensive or undesirable content for governors (FIG. 6) and blocks unauthorized content for children, employees and clients (FIG. 7). The internet filtering system limits the navigation of the internet by interfacing with an online database (FIG. 2) of web sites and their consumer-governed internet ratings that are manually assigned and does not rely upon an automated process of keyword analysis, but a governor voting and vote validation process (FIG. 5). The internet filtering system includes password protected display bars (FIGS. 3 and 4) which load automatically during web browser start-up. The governor display bar (FIG. 3) includes a vote box for not yet rated web sites, which also serves as a reporting box for incorrectly rated web sites after an internet rating has been assigned to a web site. The vote validation process (FIG. 5) is integral to the voting and reporting processes to curtail the possibility of vote fixing or invalid voting.

### BRIEF DESCRIPTION OF THE DRAWINGS

FIG. 1 Illustrates the consumer-governed internet ratings for web sites and their settings.

FIG. 2 Illustrates the database associating web sites with their internet rating settings.

FIG. 3 Illustrates the governor password protected display bar.

FIG. 4 Illustrates the user password protected display bar.

FIG. 5 Illustrates the system for assigning internet ratings through governor voting and the vote validation process.

FIG. 6 Illustrates the system for loading web sites within governor browser.

FIG. 7 Illustrates the system for loading web sites within user browser.

### DETAILED DESCRIPTION OF THE INVENTION

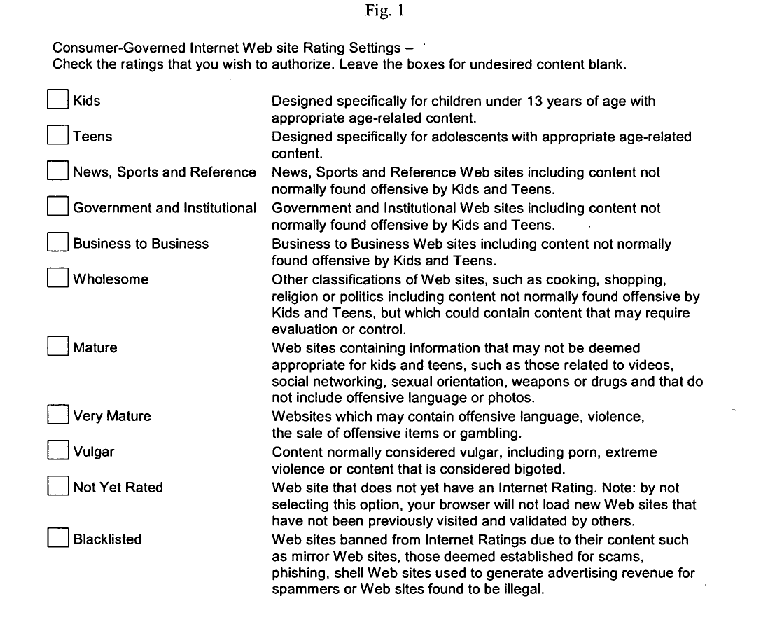

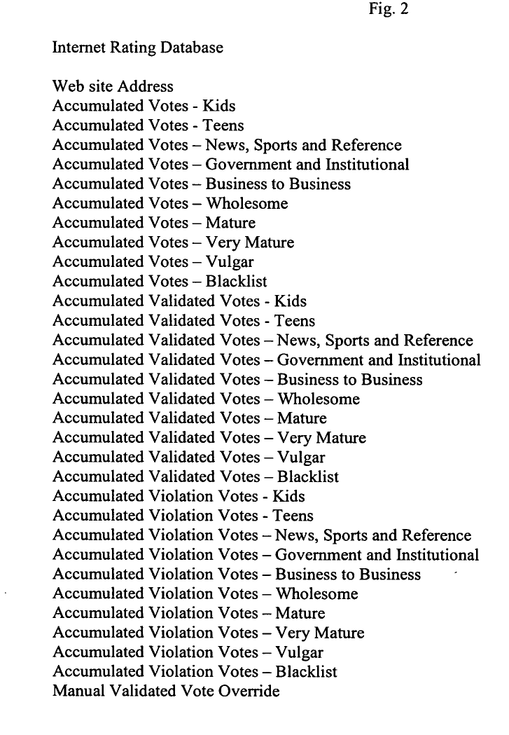

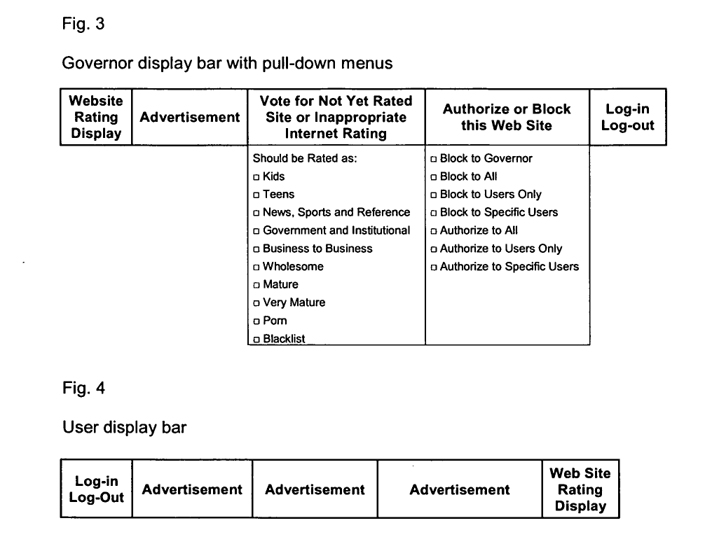

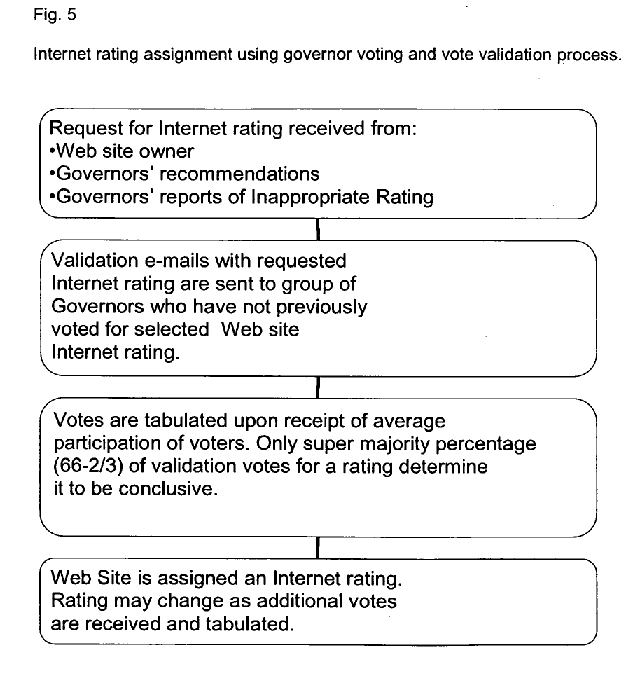

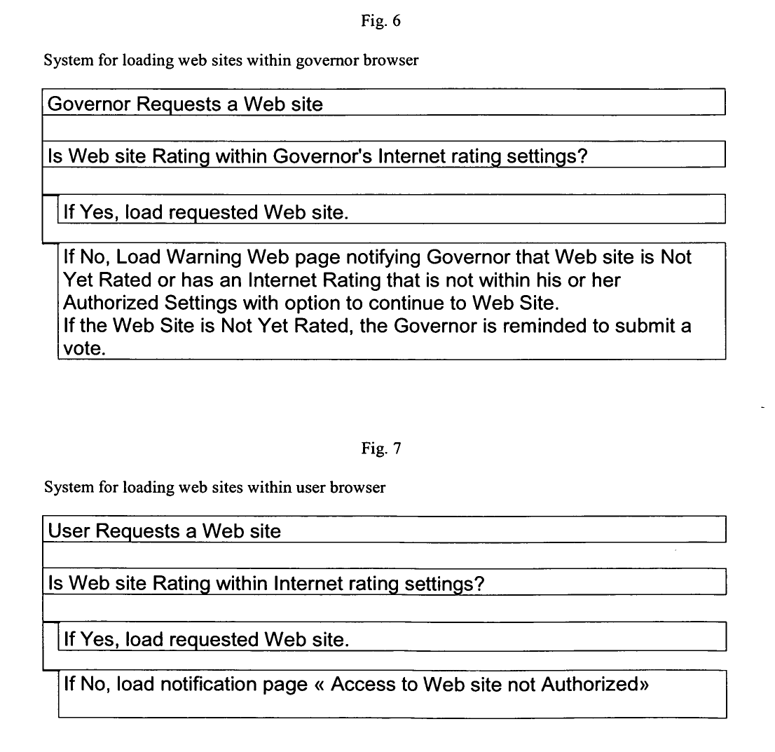

1. The invention permits the creation and assignment of consumer-governed internet ratings (FIG. 1) for internet web sites, similar to the motion picture association of America, Inc.'s trademarks; g general audiences, pg parental guidance suggested, pg-13 parents strongly cautioned, r restricted and nc-17 no one 17 and under admitted.
2. The invention relies upon a manual system for visiting and rating web sites using a database (FIG. 2), which accumulates manual internet rating votes and validated votes.
3. Invention assigns a consumer-governed internet rating based on criteria associated with each internet rating (FIG. 1).
4. Invention permits adults and employers to register as governors for its service using a payment system only available to persons over 18 years of age, such as a credit card or service such as PayPal.
5. Invention permits governors to download a password protected display bar (FIG. 3), which is similar to a tool bar, the display bar is loaded each time a web browser is loaded onto the corresponding computer's screen. Users are assigned a separate toolbar (FIG. 4).
6. Invention permits governors to block access to certain internet browsers that could be loaded onto a computer with the intention of bypassing the intended control of the display bars (FIGS. 3 and 4).
7. Invention permits a governor to select the internet rating settings (FIG. 1) that he or she determines are appropriate for himself or herself.
8. Invention permits governors to select the internet rating settings (FIG. 1) that they find appropriate to each individual minor age user, employee user or client user.
9. Invention permits governors to select the internet rating settings (FIG. 1) that they find globally appropriate for a selected computer or computer network.
10. Invention permits governors to vote for web sites that are not yet rated (FIG. 1) or to report inappropriately rated web sites. Only one vote is accepted for each IP address. Users who are not governors may not vote.
11. Invention permits governors to participate in invention's process for validating votes and incorrectly rated web sites by voluntarily receiving periodic e-mails with links to web sites that have been voted upon or reported as incorrectly rated (FIG. 5). The frequency of the e-mails (daily or weekly) and the number of web sites that a governor would be willing to visit are determined by each governor on their account settings page.
12. The validation vote e-mails are sent at random to governors who have not submitted prior votes for the polled web site (FIG. 5). A governor visits the web site contained within the validation vote e-mail and then submits a validation vote to determine whether the requested rating is within the internet rating settings criteria (FIG. 1).
13. A governor would not be asked to validate votes for web sites that have a voted internet rating outside their own internet rating settings (FIG. 1).
14. A web site owner may request an internet rating (FIG. 1) for their web site which would be validated by governors through the same system as web sites that have been voted upon (FIG. 5).
15. The responses to the vote validation process determine a web site's internet rating (FIG. 1), but may be manually overridden by the licensor of the database.
16. Validation votes are tabulated once a reliable average of votes is received.
17. Validation votes require a super, 66⅔ percent majority to determine an internet rating (FIG. 1).
18. Invention requires a password be entered each time a web browser is loaded and then loads a governor's or user's internet rating settings (FIG. 1) along with the display bar (FIGS. 3 and 4).
19. Invention interfaces with a database (FIG. 2) and blocks access to any web site outside the internet rating settings (FIG. 1) of the logged-in governor or user through their display bars (FIGS. 6 and 7), including linked access through to another web site, search engine or advertisement.
20. Invention permits governors to access any web site by manually typing its web site address. A warning page (FIG. 6) loads indicting the desired web page is outside their internet rating settings (FIG. 1) or not yet rated, in which case they are provided a reminder to vote for the web site's internet rating (FIG. 6).
21. Invention permits a database interface (FIG. 2) for search engines to filter search results using the internet rating settings (FIG. 1). They may use the database to not provide returns of web sites that are outside the governors or users internet rating settings (FIG. 1).
22. Invention permits governors to authorize web sites that are not within the internet rating settings (FIG. 1) for themselves or selected users, or to block web sites that are within the internet rating settings (FIG. 1) for themselves or selected users, with a button within the internet rating display bar (FIG. 3).

1. System of consumer-governed internet ratings assigned to web sites including all of a web site's web pages.

2. System of consumer-governed internet self-censorship.

3. System of consumer-governed internet censorship for a governor's registered users.

4. Password protected web browser display bars with an automatic load feature indicating a web site's internet rating translated into multiple languages for ease of use by governors and users.

5. A single online database of web site addresses associating those addresses with their corresponding internet rating, incorporating web sites of all languages.

6. Process for setting preferred internet ratings by adult users and employers, herein referred to as governors.

7. Process for governors to set preferred internet ratings for under-aged minors, for employees and for clients, herein referred to as users.

8. Process for blocking web sites, advertising links, links embedded within e-mails (including phishing e-mails) and links within search engine returns for web sites with internet ratings not authorized by a governor.

9. Process for authorizing specific web sites outside a governor's or user's internet rating settings or blocking websites within the governor's or user's internet rating settings.

10. Process permitting governors to vote for the internet rating of a web site or to report the incorrect rating of a web site.

11. Vote validation process to eliminate possible vote fixing of the consumer-governed internet rating of a web site.

12. Option to block web browser from visiting previously visited and validated web sites for added security of a computer.

13. Process for accessing database of rated internet web sites to search engines so they may only return search queries within a governor or user's authorized settings.
